(19) United States
(12) Patent Application Publication
(10) Pub. No.: US 2010/0105447 A1
(43) Pub. Date: Apr. 29, 2010

(54) AMBIENT NOISE REDUCTION

(75) Inventors: Alastair Sibbald, Cookham (GB); Martin Howle, Kenilworth (GB)

Correspondence Address: DICKSTEIN SHAPIRO LLP, 1825 EYE STREET NW, Washington, DC, 20006-5403, US

(73) Assignee: WOLFSON MICROELECTRONICS PLC, Edinburgh (GB)

(21) Appl. No.: 12/523,589

(22) PCT Filed: Jan. 23, 2008
(86) PCT No.: PCT/GB2008/000237

§ 371 Date: Dec. 3, 2009

(30) Foreign Application Priority Data
Jan. 25, 2007 (GB) 0701483.0

(51) Int. Cl. G10K 11/16; H04M 1/00

(52) U.S. Cl. 455/570; 381/71.6

(57) ABSTRACT

The invention provides improved ambient noise reduction for ear-worn devices, such as earphones and headphones and for other devices worn upon or used in close proximity to the ear, such as cellular telephone handsets, and it provides, in particular, improvements to “feed-forward” ambient noise-reduction systems. Most feed-forward noise-reduction systems available hitherto purport to operate only below about 1 kHz and, even then, provide only relatively modest amounts of noise reduction. In accordance with this invention, predetermined filter parameters, such as the gain and cut-off frequency of a selected filter stage used in the noise-reduction processing, are mathematically modelled and the model is adjusted in real-time, in response to user-interpretation of a graphical display of a predicted residual noise amplitude spectrum. This allows the user to inspect the predicted residual noise level amplitude spectrum and to iteratively adjust the filter parameters to minimise residual noise in a chosen environment. Instead of being made manually by a user, the iterative adjustments may be automated and implemented under computer control, using known data-fitting methods and/or neural networks.

The present invention relates to improved ambient noise reduction for ear-worn devices, such as earphones and headphones and for other devices worn upon or used in close proximity to the ear, such as cellular telephone handsets (all hereinafter individually and collectively referred to for convenience as “Ear-proximal Speaker-carrying Devices”, or briefly “ESDs”), and it relates especially (though not exclusively) to ear-worn devices of the kind used in conjunction with mobile electronic devices such as personal music players and cellular phones. It will be appreciated that the dimensions and characteristics of a speaker carried by any given ESD will be selected in accordance with the performance required of the device in question, and thus the term “speaker”, “driver” or “loudspeaker” when used herein relates to any transducer that is, or can be, driven by electrical signals to produce sounds.

The invention provides, in particular, improvements to a known form of ambient noise-reduction, known as “feed-forward” reduction, in which the ambient acoustic noise occurring around an individual, who is listening to an ESD, is detected by a microphone associated with the ESD, electronically inverted and added to the electrical drive signal applied to the loudspeaker carried by the ESD, to create an acoustic signal which, in principle, is equal in magnitude, but opposite in polarity, to the incoming ambient noise as it reaches the listener's ear. Consequently, destructive wave interference occurs between the incoming acoustic noise and its inverse, generated via the ESD's loudspeaker, thereby reducing the ambient acoustic noise level perceived by the listener.

Some ESDs are wired directly to their input devices (such as personal music players or cell-phones) via short leads and connectors, and some are coupled via wireless links, using protocols such as the “Bluetooth” format, to such input devices. The present invention can be used with both wired and wireless formats.

Moreover, there are several distinct types or families of ear-worn ESDs in use at the present time; both as single, one-ear devices, and also as stereophonic pairs, and the invention is applicable to all of them.

These various types and families of ear-worn ESDs include:

(a) so-called “ear-buds” comprising in-ear type earphones with thin acoustical sealing flange(s) of rubber or other flexible materials;

(b) in-ear type earphones (not sealed), with a relatively loose fit into the ear, and consequent significant acoustical leakage pathways;

(c) pad-on-ear earphones or headphones, with a foam or other flexible disc pad that lies flat against the pinna (outer ear flap);

(d) “supra-aural” on-ear headphones with peripheral acoustic seal: as (c) but with a thicker peripheral acoustic seal around the rim so as to achieve some acoustic attenuation of the higher frequencies permeating into the ear from the outside world; and

(e) “circumaural” headphones, in which a larger housing is used, slightly bigger than the pinna itself, such that when located in position against the side of the head, a large, cushion-type seal (of rubber or another flexible material) around the rim of the housing forms a substantial acoustic seal between the ambient and the inner cavity now existing between the ear and the inner surface of the headphone shell.

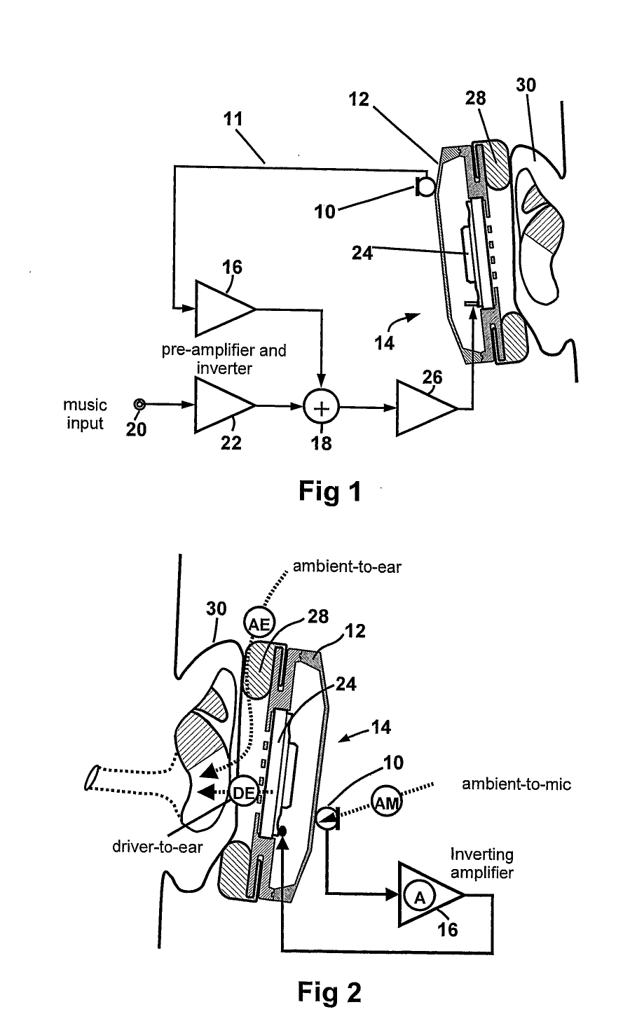

As previously mentioned, the present invention relates exclusively to the feed-forward method of noise reduction, which is depicted in a basic form in FIG. 1, and can be employed with all of the different ear-worn ESDs described above, as well as with ESDs held close to the ear, such as cellular telephone handsets.

Referring now to FIG. 1, at least one microphone 10 is placed on the exterior of the housing, or shell 12 of an ESD 14; the microphone 10 thus being associated with the ESD 14 in order to detect the ambient noise and generate an electrical output signal, indicative of the detected ambient noise; the electrical output signal being inverted in a pre-amplifier and inverter circuit 16, and added, by means of a summing circuit 18, to an incoming music (or speech) input signal derived, for example, from an input device (not shown) such as a personal music player or a cell-phone, and received at a terminal 20 for application to the summing circuit 18 by way of a buffer amplifier 22.

The summing circuit 18 feeds the loudspeaker 24 of the ESD 14 by way of a drive amplifier 26, causing the loudspeaker to generate an acoustic signal having two basic components, namely a desired component, comprising the music or speech received from the input device and which the listener wants to hear, and a “cancellation signal” representing the inverse of the ambient noise detected by the microphone 10. Destructive wave-cancellation, between the cancellation signal and the directly received incoming ambient acoustic noise, occurs adjacent to the loudspeaker outlet port of the ESD 14, within the cavity between the shell 12 (with its associated foam pad 28) and the outer ear, schematically shown at 30. For this to occur to a meaningful degree, the cancellation signal must, in principle, have a magnitude which is equal to that of the incoming noise signal, and it must be of opposite polarity (that is, inverted, or 180° shifted in phase with respect to the noise signal).

The feed-forward principle forms the basis of various ambient noise-reducing ESD systems that are commercially available at the present time. However, in such systems, even when the cancellation signal is optimally adjusted and balanced, significant residual noise remains. It is thus common to observe that most commercial systems are only claimed to operate below about 1 kHz, and, even then, provide only relatively modest amounts of noise reduction.

The reasons for the inefficiency of the feed-forward approach have not been fully appreciated to date, although there have been many attempts to improve it, for example by the use of associated electronic filtering, or by very sophisticated methods, such as the use of adaptive filters to “tune out” periodic noise.

The state of the art in this respect has recently been summarised in an article, by W S Gan, S Mitra and S M Kuo in IEEE Transactions on Consumer Electronics, 51, (3), August 2005, which describes attempts to analyse and identify the various components of the incoming noise, primarily for repetitive noises, using a digital signal-processor (DSP), and then to modify an electronic filter in real-time to provide an optimal cancellation signal. However, despite considerable mathematical and engineering effort, this approach has met with limited success. For example, it can be seen from FIG. 15 of “Analogue Active Noise Control” by M Pawelczyk, published in Applied Acoustics, 63, (2002), pp. 1193-1213 that the reduction bandwidth of a state-of-the-art adaptive system is limited to frequencies below about 500 Hz. Also, Pawelczyk notes that such systems cannot suppress impulsive, non-repetitive noise.

There is thus a need for ambient noise suppression systems having improved performance, and the present invention aims to provide such systems and methods by which the improved systems can be designed and configured.

According to the invention, therefore, there is provided, in or for a feed-forward noise reduction system for reducing ambient noise perceived by a person utilising at least one ear-proximal speaker-carrying device (“ESD”); the system including microphonic means for detecting ambient noise and for producing electrical signals indicative of the detected noise, means for inverting the electrical signals and for converting, by means including the speaker of said ESD, the inverted signals into output sounds intended for destructive acoustic combination with the ambient noise, and a signal processor means for imposing predetermined filter parameters upon said electrical signals; a method of defining said parameters comprising the steps of:

(a) measuring phase and amplitude response data indicative of the response of the ESD-proximal ear to selected ambient noise;

(b) measuring phase and amplitude response data indicative of the response of the microphonic means to selected ambient noise;

(c) measuring phase and amplitude response data indicative of the response of the ear to the ESD;

(d) utilising the measured response data to predict operational values for said filter parameters; and

(e) adjusting the predicted values in a sense adapting the system to reduce ambient noise having one or more specified characteristics, thereby to generate said predetermined filter parameters.

In one preferred embodiment of the invention, the ESD comprises a supra-aural pad-on-ear headphone, and such a device preferably incorporates a plurality of microphones arranged around the rim of a headphone capsule. In other preferred embodiments, the ESD comprises an ear-bud or a cellular telephone handset.

It is further preferred that the ESD incorporates a high-compliance loudspeaker with a relatively flat frequency-dependent amplitude response, good low-frequency performance and a vented rear cavity.

In such embodiments, the signal processing means is preferably configured to provide sufficient electronic filtering to align the amplitude and phase characteristics of the ambient noise respectively with those of said output sounds at the ear.

Preferably, electronic compensation for low-frequency roll-off of the high-compliance loudspeaker is provided by a pair of first-order low-pass filters, arranged in series to form a shelf-filter.

Preferably, the phase and amplitude response data indicative of the response of both the ESD-proximal ear and second transducer means to selected ambient noise, and also of the response of the ear to the ESD, are measured by placing the device on to an artificial head measurement system and, further preferably, these measurements are made in an anechoic chamber.

In preferred embodiments, the ambient noise to be measured is generated by a reference-grade loudspeaker placed at a predetermined distance and azimuth angle to, and in the same horizontal plane as, the artificial head. The measurements are preferably made using swept-sine-wave or impulse methods using computer-based acoustic measurement apparatus.

Each measurement comprises a frequency-dependent amplitude response and an associated frequency-dependent phase response.

A residual noise signal can be computed by vector subtraction of the noise cancellation signal from that noise signal which would be present at the ear with the noise-reduction system inactive, and can be displayed as an amplitude spectrum.

In order to minimise the residual noise signal for a predetermined kind of ambient noise, the control exerted by the signal processor means for imposing predetermined filter parameters, such as the gain and cut-off frequency of a selected filter stage upon said electrical signals, is preferably mathematically modelled; said model being adjustable in real-time, in response to user-interpretation of a graphical display of the predicted residual noise amplitude spectrum provided in response to the measurement process.

Usefully, this allows the user to inspect the predicted residual noise level amplitude spectrum, and to iteratively adjust the filter parameters for optimum results (minimal residual noise) in the circumstances under review. When the user is satisfied with the qualities of the residual noise spectrum, the filter parameters are translated into the appropriate electronic component values for use in the signal processing means. Further, in this way, the noise reduction can be “tuned” or “profiled” so as to match particular needs.

Instead of being made manually by a user, the iterative adjustments may be automated and implemented under computer control, using known data-fitting methods and/or neural networks.

The invention also encompasses an ESD provided with a noise-reduction system incorporating a filter means exhibiting predetermined filter parameters defined by any of the foregoing methods.

In order that the invention may be clearly understood and readily carried into effect, some useful background material will be discussed, and then certain embodiments thereof will be described, by way of example only, all with reference to the accompanying drawings, of which:

FIG. 1 has already been referred to;

FIG. 2 indicates an ESD disposed typically in relation to an ear, and illustrates four primary transfer functions;

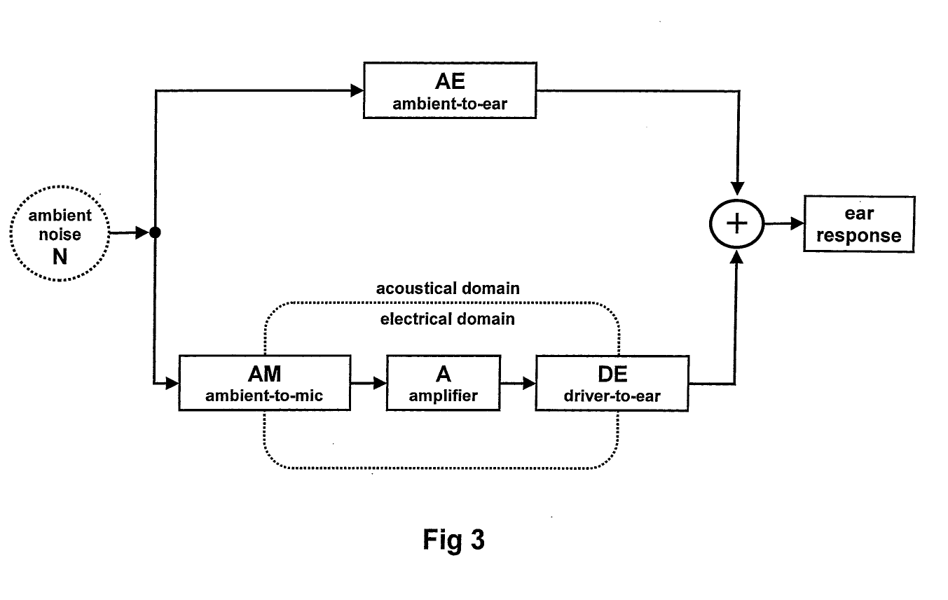

FIG. 3 shows in schematic, block-diagrammatic form, a connectivity relationship between the transfer functions illustrated in FIG. 2;

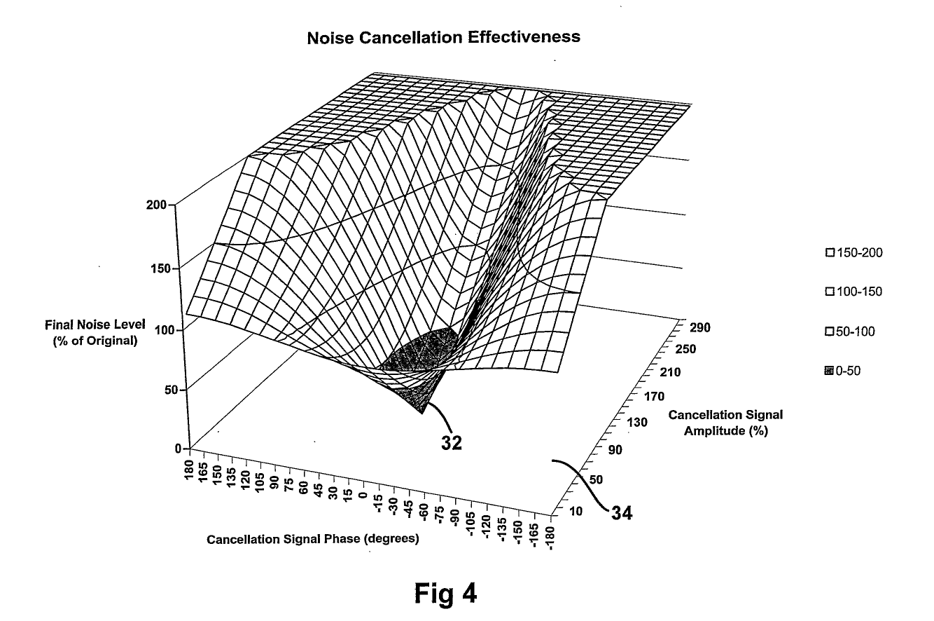

FIG. 4 is a graphic representation showing the sensitivity of the effectiveness of noise-reduction to variations in amplitude and phase;

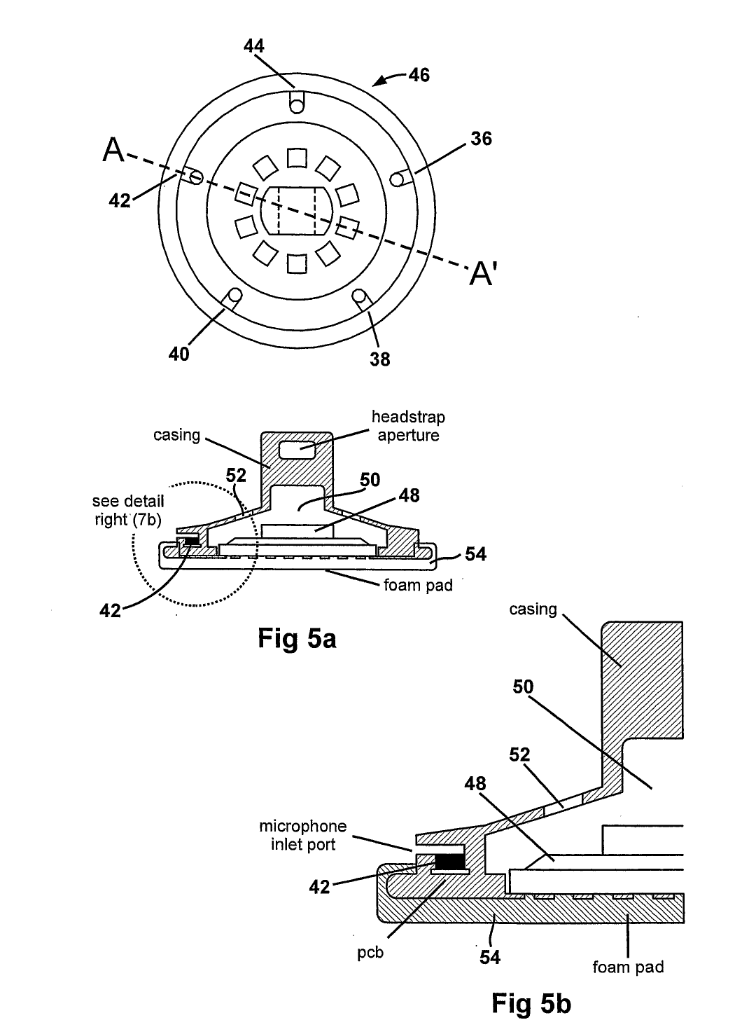

FIGS. 5(a) and 5(b) show a pad-on-ear headphone structure beneficially usable with the invention;

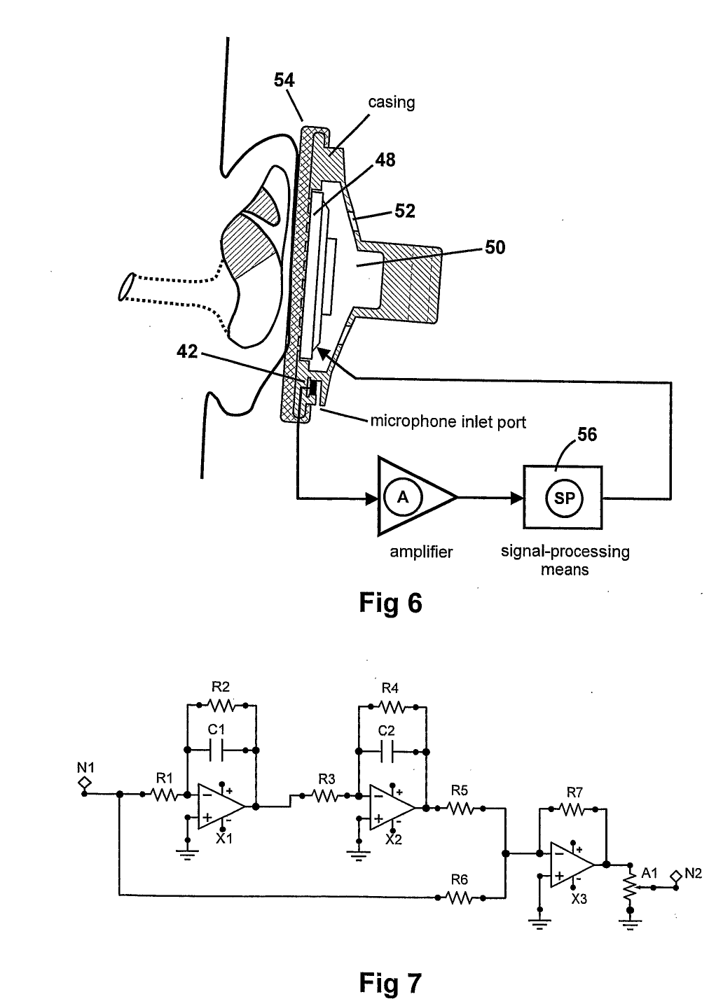

FIG. 6 shows an exemplary system for implementing a method in accordance with one embodiment of the invention;

FIG. 7 shows low-frequency compensation circuits;

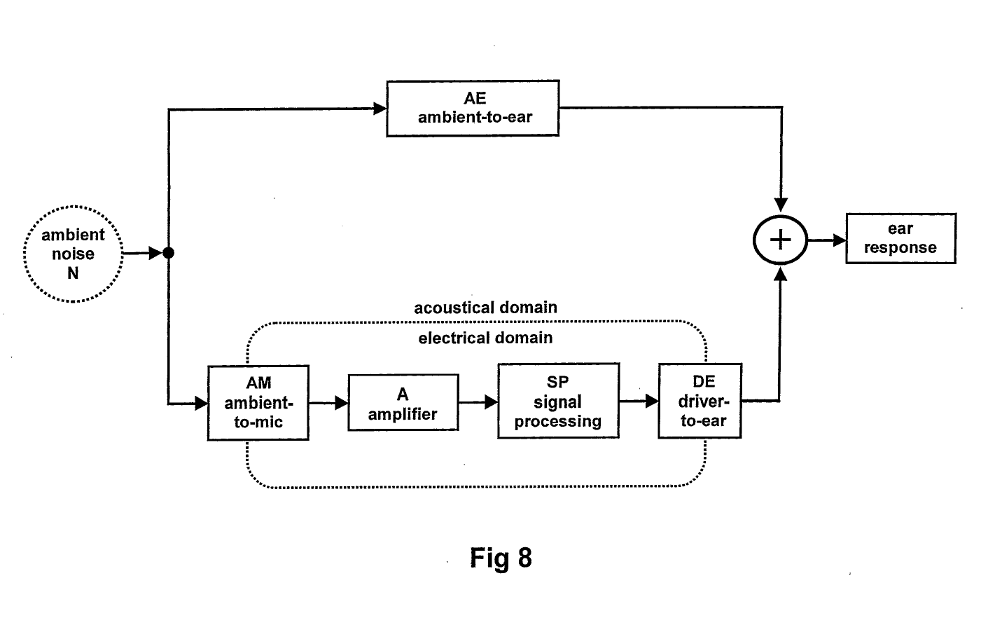

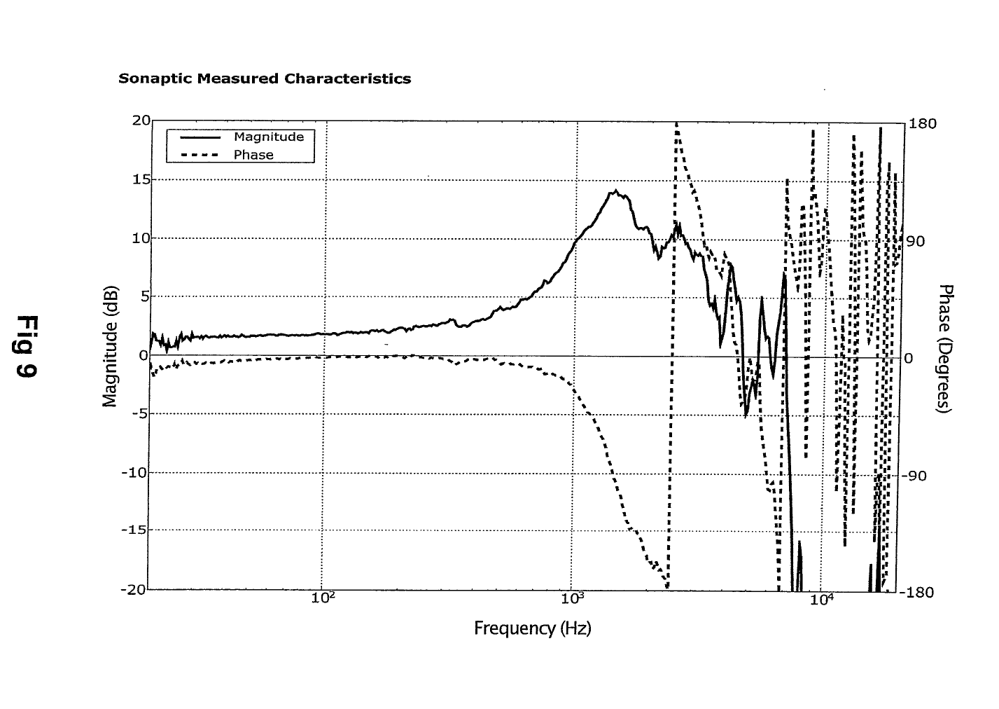

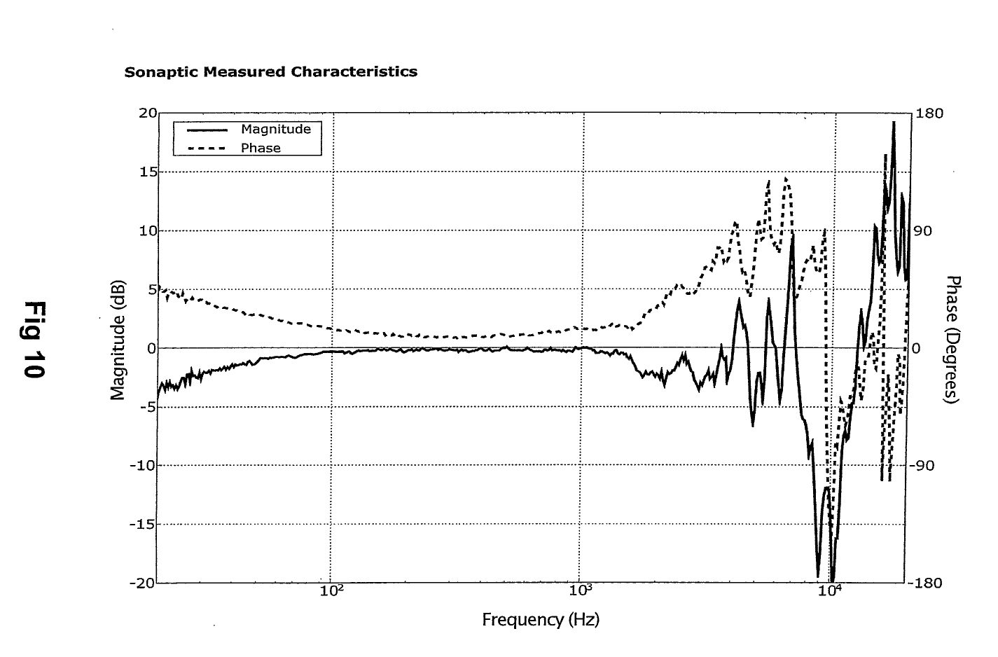

FIG. 8 is a block diagram showing typical signal connectivity for use with certain embodiments of the invention;

FIG. 9 shows graphically an ambient-to-ear transfer function for a pad-on-ear system;

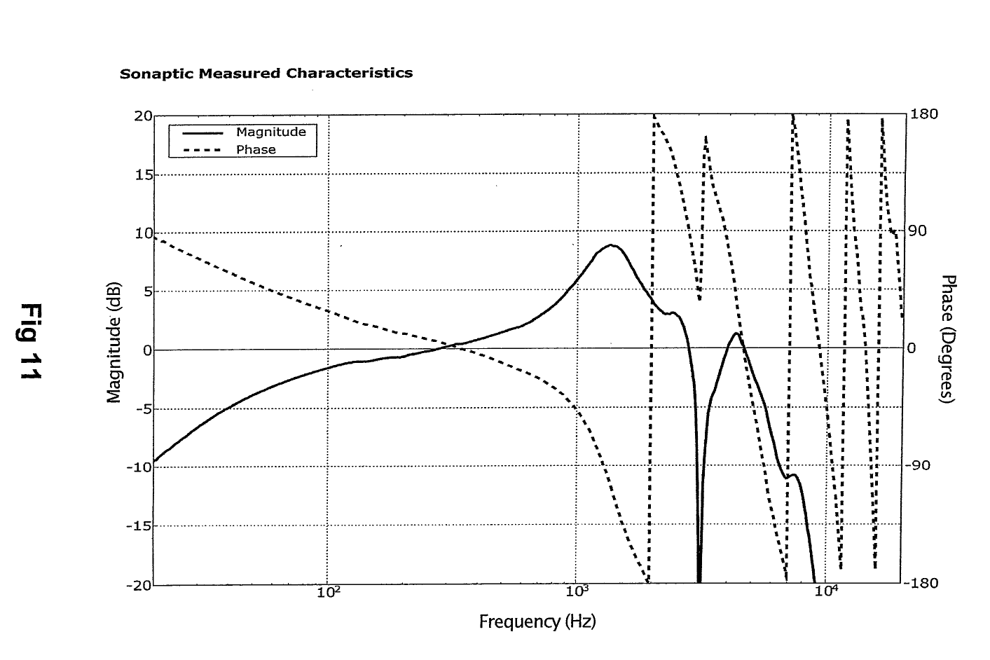

FIG. 10 shows graphically an ambient-to-microphone transfer function for a pad-on-ear system;

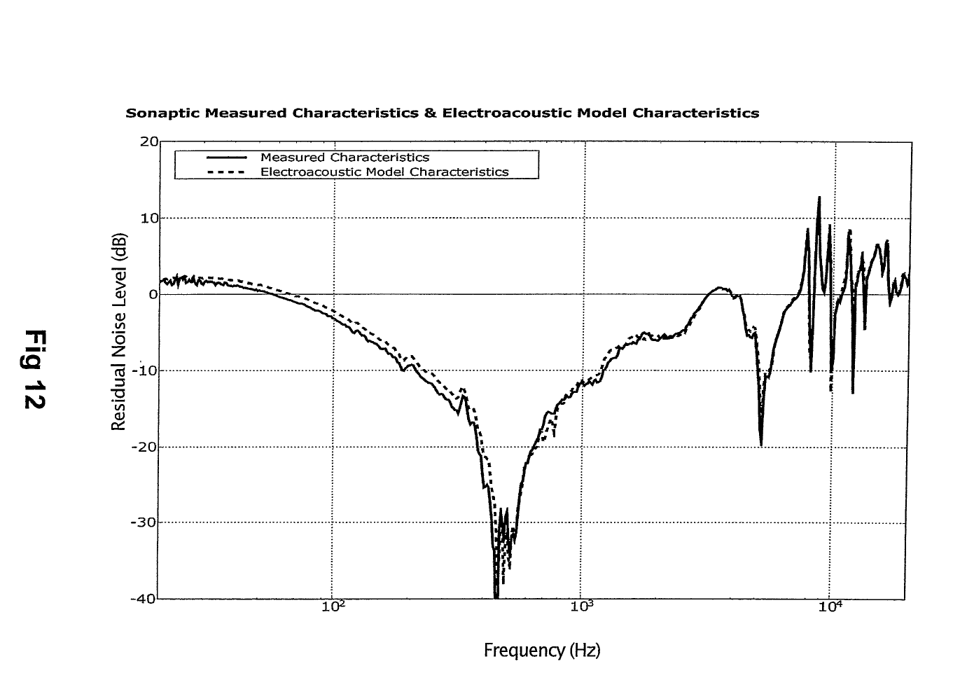

FIG. 11 shows graphically a driver-to-ear transfer function for a pad-on-ear system;

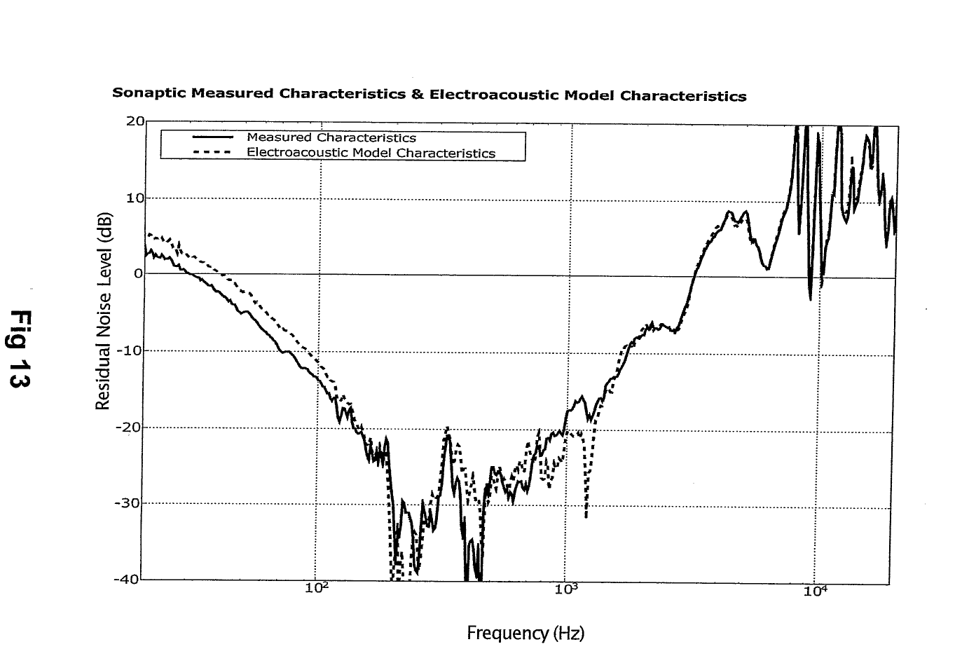

FIG. 12 shows graphically a residual noise level (RNL) spectrum using basic noise-reduction without signal processing;

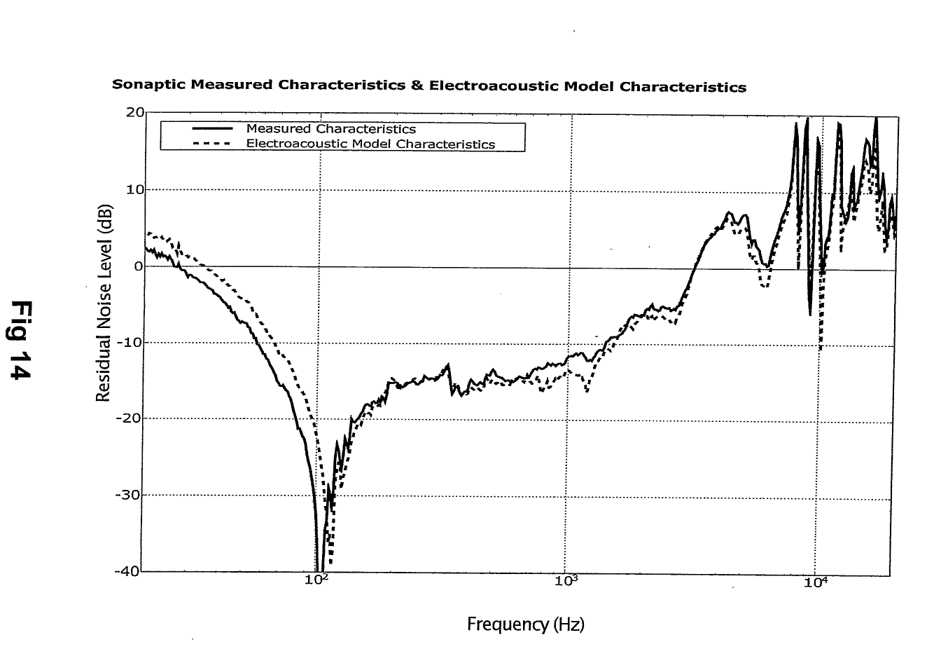

FIG. 13 shows graphically a residual noise level (RNL) spectrum associated with compensated noise-reduction, with signal processing optimised for general-purpose usage;

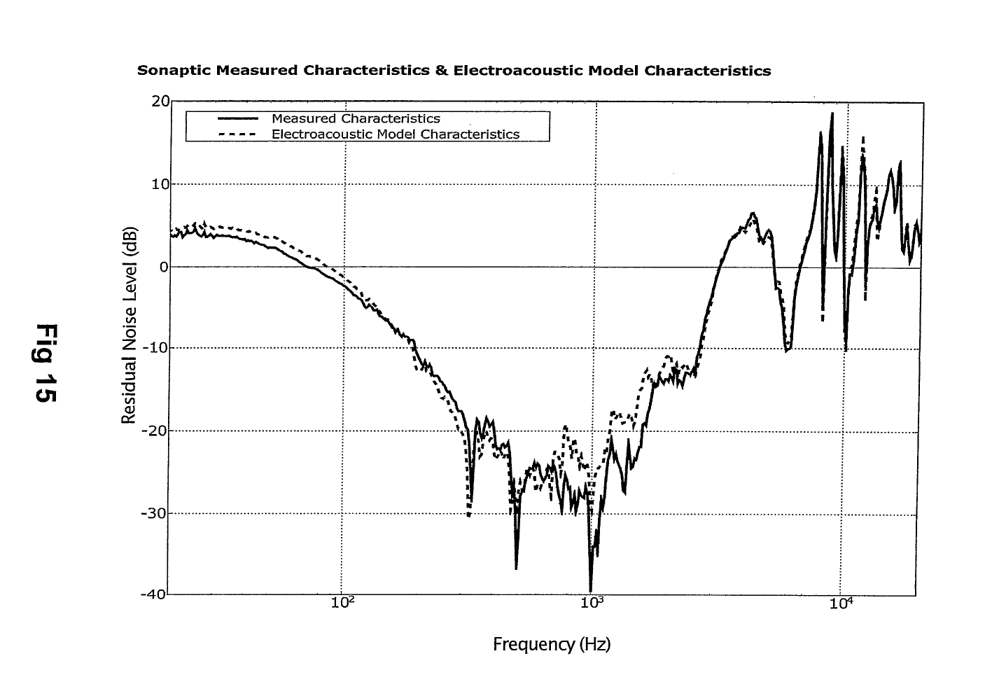

FIG. 14 shows graphically a residual noise level (RNL) spectrum associated with compensated noise-reduction, with signal processing optimised for a spot frequency at 100 Hz;

FIG. 15 shows graphically a residual noise level (RNL) spectrum associated with compensated noise-reduction, with signal processing optimised for the speech band;

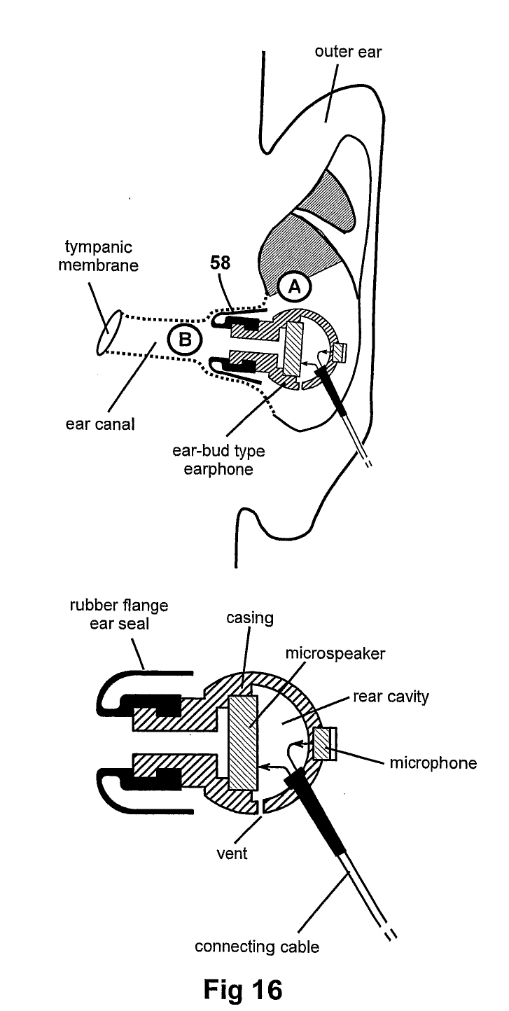

FIG. 16 shows an exemplary system for implementing a method in accordance with a second embodiment of the invention in an ear-bud structure;

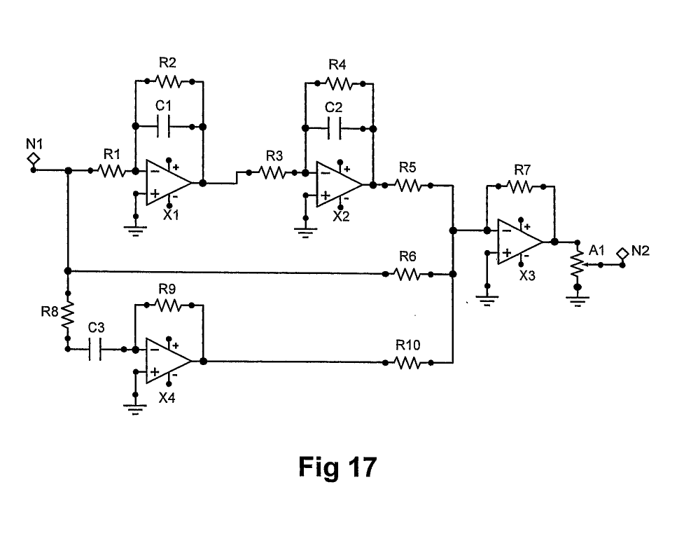

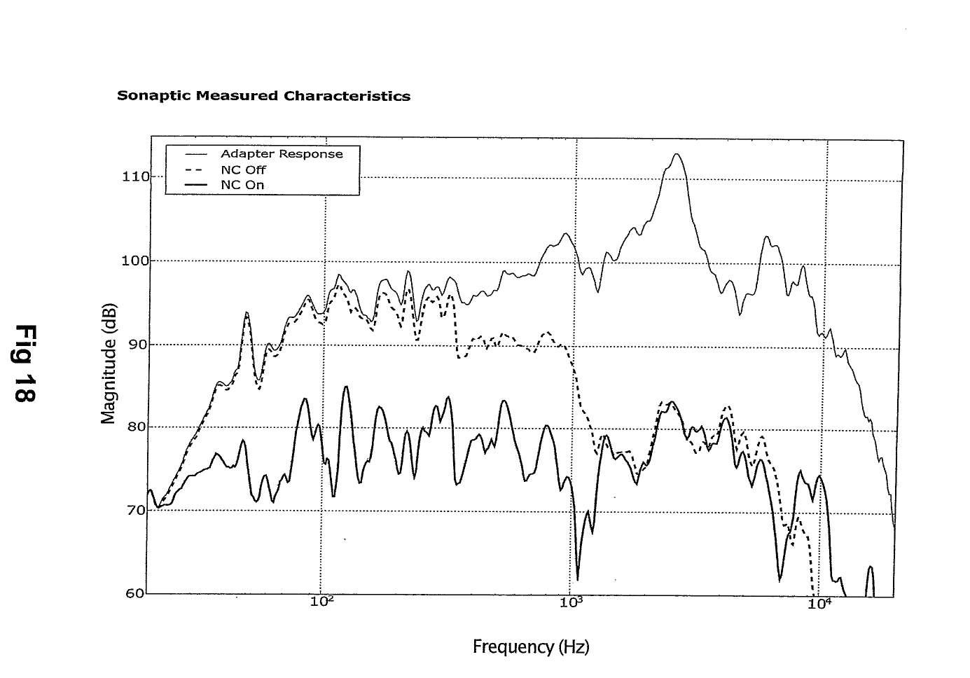

FIG. 17 shows low-frequency compensation circuits with added high-frequency compensation; and

FIG. 18 shows graphically a residual noise level (RNL) spectrum associated with compensated noise-reduction for an ear-bud, with signal processing optimised for general-purpose usage.

The inventors hereof have appreciated that providing improved feed-forward ambient noise reduction requires an appreciation of certain key factors, including the following:

(a) the physical pathways followed by the incoming ambient acoustic energy and the sounds generated by transducing electrical signals indicative, in principle of the inverse of the ambient acoustic energy;

(b) the way in which the ambient energy and the transduced sounds are combined; and also

(c) the ways in which these two acoustic components are modified, prior to their eventual combination, by the electrical and acoustical properties of the system.

Embodiments of the present invention take account of these key factors, in order to provide an effective processing means according to any particular preferred noise-reduction criterion.

The above-mentioned physical pathways are shown in FIG. 2, and can usefully be represented in the block diagram of FIG. 3; each pathway having associated therewith a respective transfer function. Each of these transfer functions includes not only a (frequency dependent) amplitude characteristic, but also an associated (frequency dependent) phase characteristic. As shown FIGS. 2 and 3, there are four of these primary transfer functions, as follows:
1: Ambient-to-Ear; defined hereinafter as AE.
This represents the acoustical leakage pathway by which external ambient noise directly reaches the ear, and includes transmission around the shell 12 and through the foam pad 30 of the ESD 14.
2: Ambient-to-Microphone(s); defined hereinafter as AM.
This represents the acousto-electric response of the external microphone 10 (or microphones) as deployed in their operational mode, which includes local acoustical effects (for example, of the listener's head).
3: Driver-to-Ear; defined hereinafter as DE.
This represents the electro-acoustic couple between the driver unit (a small, high-compliance loudspeaker 24) and the eardrum of the listener. This is strongly influenced by the nature of the acoustical load that it drives, a key feature of which is the acoustical leakage pathway AE between the ear-to-driver cavity and the external ambient.
4: Electronic Amplification; defined hereinafter as A.
This is the electrical transfer function of the amplifier. Although it is commonplace to provide an amplifier having a “flat” (i.e. relatively constant) amplitude characteristic as a function of frequency, it is usually necessary or convenient in practice to incorporate one or more AC coupling stages, and these behave as first-order low-cut (high-pass) filters. Even though these can be implemented such that their characteristic cut-off frequencies lie well outside the frequency range of interest for noise cancellation, such as 10 Hz or below, for example, the inventors hereof have observed that these intrinsic AC coupling stages have a significant influence on the overall phase response, and that it is essential to take account of them.

These transfer functions cause both the incoming ambient noise and the signal generated by the ESD's loudspeaker 24 to undergo transformations owing to various phenomena such as acoustical resonance in the ESD shell cavity, for example. In U.S. Pat. No. 5,138,664, for example, (hereinafter referred to as “US664”) it was noted that these transformations would modify the respective amplitude responses of the signals, and that this would prevent total cancellation from occurring. However, no similar significance was attributed to the phase of the two signals, and no details of phase processing or phase responses were given. It was proposed in theory that, if these various transfer functions were to be combined mathematically, an ideal electronic filter could be created to take account of, and anticipate, all of these effects. Such a filter could then be incorporated into the electronic amplifier so as to operate serially between the microphone signal and the loudspeaker. However, no details of such a filter were disclosed, only amplitude response plots of ambient-to-ear leakage (US664 FIG. 4), a microphone characteristic (US664 FIG. 5) and the ratio of the two (US664 FIG. 6), in order to show that, because the ratio was relatively flat, only a “slight correction” to the loudspeaker response via the filter (referred to as a “control circuit”) would be needed.

Accordingly, although the principle of US664 is valid, there is insufficient information in the disclosure to enable the creation of a suitable filter to compensate for the various functions.

There are further uncertainties related to the making of the various measurements themselves. In practice, an artificial head system is a known and preferred means to measure these functions, even though it might not truthfully mimic the properties of any human individual. Measurements are typically carried out by using a reference loudspeaker sited about 1 metre from the artificial head in an anechoic chamber, and at a particular direction with respect to the artificial head (for example, at 90° azimuth in the horizontal plane). The artificial head system is fitted with the relevant noise-reducing ESD unit, and the transfer functions (comprising both amplitude and phase data) are measured using known methods, such as the use of a swept sine-wave or by an impulse fed into the speaker. The responses are measured via the microphones both in the artificial head (AE; DE) and in the ESD unit itself (AM). However, there are some major practical difficulties in measuring and quantifying the three acoustically related transfer functions AE, AM and DE in order to combine them to form the requisite correction filter function, as follows.
1. Variations in the physical placement of the ESDs on the artificial head results in experimental variations in acoustical leakage between the ear-cavity and the ambient with consequent measurement uncertainties. These variations are significantly exacerbated when using several functions together.
2. The AE and AM transfer functions are direction dependent; a factor which has neither been observed nor described previously. When measurements are made from differing directions, the measured responses can be different, owing to the acoustic asymmetry of the outer ear, and it is not valid to use a transfer function which has been measured at one particular azimuth angle at other, different angles. This limitation has been overcome recently, as described and claimed in our co-pending UK patent application GB 0601536.6, by the use of time-aligned signals and an associated multi-microphone array, that provides a degree of direction matching between the AE and AM functions.

Finally, US664 defines an equation for a filter (“control block”) β, using the various transfer functions, and which would provide theoretically perfect noise cancellation.

$$β = \frac{- F}{{A}_{1} HM} \qquad ( 1 )$$

Here, the terms F, A₁, H and M correspond respectively to AE, A, DE and AM as defined above.

However, the simple act of defining this equation does not mean that such a filter can be practically devised. For example, a theoretical derivation might require the filter to incorporate a negative time-delay, which of course is not feasible. Neither can it be construed by a relative delay method, because the incoming acoustical noise arrives when it arrives and cannot be delayed. The electronic filter must operate in real-time. In view of the widely varying properties of the transfer functions, it is impossible to conceive that such an equation can be solved to provide perfect ambient noise cancellation over a wide range of frequencies.

The present invention acknowledges this limitation, and provides a practical means to minimise the residual noise over a desired range of frequencies, rather than a theoretically correct, but impractical, concept for reducing the residual noise signal to zero at all frequencies.

The relative phase of the sounds generated by transducing the cancellation signal with respect to the ambient noise is a factor equally important as their relative amplitudes. Both factors are equally critical for achieving effective ambient noise-reduction. Although this might seem at face value to be an obvious statement, it is observed that, whilst the various prior-art disclosures in respect of ambient noise-reduction refer to the use of electronic filters to modify the amplitude response, there are no explicit descriptions about dealing with the phase response. For example, U.S. Pat. No. 6,069,959 describes a complex filtering arrangement for use with a feed-forward noise-reduction system, and discloses many graphs depicting the amplitude response. However, there are no accounts of, or references to, the phase response.

It seems that prior-art disclosures have neglected the importance of the phase response of the cancellation signal with respect to the incoming ambient noise. Furthermore, the resultant effects of incorrectly matching the amplitudes (and relative phase) of the two have not been quantified. In order to rectify this, and to discover how sensitive the noise-reduction process is to variations in amplitude and phase, simultaneously, above and below the optimum values, the inventors hereof have carried out extensive analysis to define the effectiveness of the noise-reduction process in terms of the remaining amount of (non-cancelled) noise, i.e. the “residual” noise signal, both as fraction (percentage), and also in terms of a logarithmic reduction of the noise sound pressure level (SPL), in dB units.

Somewhat surprisingly, this analysis revealed that relatively tight tolerances are needed for even a modest amount of noise reduction. If 65% reduction (−9 dB) is to be achieved (residual noise signal=35%), then, assuming perfect phase matching, the amplitude of sounds transduced from the above-described “cancellation signal” must be matched to that of the actual ambient noise to which those sounds relate to within ±3 dB. Similarly, even if their amplitudes are perfectly matched, their relative phase must lie within ±20° (0.35 radian).

FIG. 4 represents a three-dimensional surface which shows the residual noise fraction as a function of both amplitude and phase deviations from the perfect match, from which the critical nature of the relationship is clear. The >50% cancellation region (−6 dB or better) is represented by the lowermost region 32 of the narrow funnel shape descending centrally to the floor 34 of the plot. Any departure from this ideal region significantly compromises the effectiveness of the system.

To further quantify this, at 2 kHz the above-mentioned 20° phase-matching requirement corresponds to a time period of only 28 μs, which represents an acoustic path length of only 10 mm. Hence, the ambient noise and its inverted counterpart transduced from the cancellation signal must be spatially aligned to better than 10 mm for, at best, −9 dB cancellation at 2 kHz.

The present invention provides, inter alia, a method for determining the optimal characteristics of one or more electronic signal processing filters for use in a feed-forward ambient noise reduction system. In one embodiment, the invention utilises a computer program to combine several physical acoustical measurements from a noise-reducing ESD with mathematically-derived electronic filter characteristics, thereby deriving the frequency-dependent characteristics of a resultant residual noise signal, which characteristics are visually displayed as a noise spectrum. By iterative adjustment of the mathematical filter parameters, a user can optimise the residual noise spectrum so as to suit a preferred criterion or set of criteria. The resultant filter characteristics are then embodied into electronic hardware and incorporated into the respective noise-reducing ESD.

It is important to note that the computations are carried out using vector algebra, in order to correctly take account of both phase and amplitude during arithmetical operations.

For clarity of description, and for simplicity in some of the accompanying drawings, a single microphone system has been depicted, although it should be noted that a time-aligned, multi-microphone arrangement is preferred, because it is more effective in use. Also, whilst the following description and drawings relate to analogue circuit implementations, it will be appreciated that ambient noise reduction signal processing can alternatively or additionally be carried out in the digital domain; the invention is equally valid for both analogue and digital processing routes and may employ mixed analogue and digital technology if preferred in any given situation.

In the following examples of specific embodiments of the invention, optimum signal-processing methods are established for two different ESD types, namely (a) a pad-on-ear headphone system; and (b) an ear-bud type earphone.

### EXAMPLE 1

### Pad-on-Ear, Open Type Noise-Reducing Headphone

This type of headphone system has been described in the aforementioned UK patent application GB 0601536.6 and comprises an array of five microphones 36, 38, 40, 42 and 44 around the rim of a 60 mm diameter headphone capsule 46, as shown in FIG. 5. A high-compliance loudspeaker 48 is used, with a relatively flat response and good low frequency performance (for example, having a resonant frequency below 100 Hz). The rear volume 50 of the loudspeaker cavity is vented (at 52) to the ambient, and the front volume of the loudspeaker is coupled to the ear via a foam pad 54 which, acoustically, is relatively transparent. Accordingly, there is quite a large leakage between the ear-to-phone cavity and the ambient. This combination of factors is designed to minimise any acoustical resonances in the various transfer functions, such that minimal electronic filtering is required in order to align the amplitude and phase characteristics of the noise signal and cancellation signal at the ear. Such filtering is incorporated into the amplification electronics, for example as a serial processing block, as shown at 56 in FIG. 6.

Nevertheless, the low-frequency roll-off characteristic of the loudspeaker 48 causes its amplitude response to fall in the frequency region below its resonant frequency, with a consequent rise in its phase characteristic. These departures from the ideal are significant, in noise-reduction terms, even at frequencies up to one order of magnitude above the resonant frequency, and must be compensated for electronically if effective noise-reduction is to be achieved. Theoretically, in free-field conditions, a moving-coil loudspeaker has a low-frequency roll-off factor of 12 dB per octave, although this is dependent on damping conditions and it is further modified when the speaker is coupled to drive into an acoustical load, as happens when used with a pad-on-ear system, with its associated compliance and leakages.

The inventors hereof have observed that the need for electronic correction of the loudspeaker low-frequency roll-off is important to feed-forward noise-reduction systems of all types, including ear-bud type earphones. This correction is not in any way related to the proximity of the loudspeaker 48 to the head or ear, for it is essentially an intrinsic property of the loudspeaker itself, as can be measured in a free-field, modified by acoustical loading. The inventors have also discovered that a pair of first-order low-pass filters, arranged to form a shelf-filter (that is, tending to a constant gain value above the cut-off frequencies), can provide effective compensation for the low-frequency amplitude and phase properties of the loudspeaker.

A schematic diagram of an analogue implementation of this embodiment is shown in FIG. 7, which operates as follows. First, the signal from the microphone buffer amplifier is fed into node N1, from which it feeds amplifiers X1 and X2, each configured as a first-order low-pass filter, and arranged in series. The output of amplifier X2 is summed (via R5) together with the original signal (via R6) by means of a summing amplifier X3. The output of the summing amplifier X3 is fed from node N2 to the headphone driver amplifier via potentiometer A1, which allows the overall system gain to be trimmed to the correct value. The low-frequency gain of stages X1 and X2 is set by the ratios (R2/R1) and (R4/R3) respectively, and the high frequency gain tends to zero owing to the provision of C1 and C2 respectively in their feedback loops. As both amplifiers invert the signal, but are in series, the double inversion results in a non-inverted output which is added to the original, flat-response microphone signal. The cut-off frequencies, F_{c}, of the two filters are determined by the values of the feedback components R2 and C1 (for X1) and R4 and C2 (for X2) by the relationship: F_{C}=(½πRC).

Consequently, if X3 is set to unity-gain configuration, by setting R5, R6 and R7 to be all of equal value, then at high frequencies the gain of the entire circuit of FIG. 7, from N1 to N2, is unity (because the high-frequency gain of X1 and X2 tends to zero); and at low-frequencies it asymptotes to a value defined by: Gain_{LF}=1+{(R2/R1)×(R4/R3)} (where the “1” represents the contribution from N1 via R6).

It will be appreciated that, when the residual noise levels are calculated, the properties of these filters are calculated using their complex properties such that the respective signal vectors are combined correctly.

The three acoustically related transfer functions AE (ambient-to-ear), AM (ambient-to-microphone(s)) and DE (driver-to-ear) are, in this embodiment, measured by placing the noise-reducing headphone system on to an artificial head measurement system, such as a Bruel & Kjaer type 5930 or 4128, fitted with a type 4158 ear simulator or its equivalent. Preferably, these measurements are made in an anechoic chamber. A reference-grade loudspeaker (e.g. Tannoy Mercury F2) is conveniently used as the sound source, placed at a predetermined distance and azimuth angle (typically 1 metre and 45° respectively) in the same horizontal plane as the artificial head. The measurements are made using known swept-sine-wave or impulse methods using computer-based acoustic measurement apparatus such as, for example, the CLIO system (Audiomatica SRL, Firenze, Italy).

Each transfer function measurement comprises of (a) the frequency dependent amplitude response; and (b) the associated frequency dependent phase response.

Examples of these transfer functions are shown in FIGS. 9, 10 and 11, which show respectively the AE, AM and DE functions derived from measurements made on a five-microphone pad-on-ear headphone system of the type shown in FIGS. 5 and 6, using a high-compliance 38 mm loudspeaker. In FIGS. 9 to 11, the solid lines represent the amplitude data, and the dashed lines represent the phase data, scaled using the left and right y-axes respectively. The amplitude and phase data of the AE and AM plots in FIGS. 9 and 10 are provided as relative to a reference microphone (B&K type 4006) placed directly adjacent the headphone shell, in order to subtract out both the external loudspeaker characteristics and also the time-of-flight delay (which would significantly distort the phase data) from the external speaker to the ear and headphone system. In use, as described below, this compensation is not required; it has been done purely to clarify the content of the graphs. Significant features are as follows.

The large amplitude peak (and large associated phase changes) at around 1.5 kHz in the ambient-to-ear function shown in FIG. 9 is caused by the outer-ear cavity to phone interface. The ambient-to-microphone(s) transfer function shown in FIG. 10 is relatively flat up to about 4 kHz, when phase differences in the microphone array introduce some comb filtering. These effects, however, lie above the active noise-cancellation range, and are not of great importance. The driver-to-ear transfer function shown in FIG. 11 is the most heavily influential of the three, featuring both (a) the intrinsic, low-frequency roll-off of the loudspeaker, here below about 100 Hz, and (b) a resonant peak which is somewhat similar to that of the AE function because it also involves the same resonant cavity.

When observing the individual complexity and magnitude of these three functions, and bearing in mind their sensitive dependence on the physical properties of the headphone hardware, it is not surprising that the various prior-art disclosures relating to their influence have seemingly remained unfulfilled in both practical and commercial terms. Embodiments of the present invention however provide a rapid and user-optimisable means for employing the relevant transfer function data in order to create effective and practical signal-processing means for feedforward noise-cancellation.

These measurements are stored as data files, and transferred to a computer. It should be noted that the ambient-to-ear (AE) and ambient-to-microphone (AM) functions inherently include the transfer characteristics of the reference loudspeaker, and also their phase characteristics include a time-delay element owing to the time-of-flight distance between the loudspeaker and the measurement microphones. However, both of these influences cancel out exactly in the subsequent mathematical treatment, leaving pure response data. Next, the amplifier transfer function (A) is measured using the same system and method (although this is purely an electrical measurement in and out of the amplifier).

It is now possible to calculate the residual noise spectrum for a simple “invert and add” system of the kind shown in FIG. 1, which does not use any additional signal processing. The ambient noise signal is defined to be N (a function of frequency). The residual noise signal can be computed by vector subtraction of the noise cancellation signal from that noise signal which would be present at the ear with the noise-reduction system inactive, as follows:

Residual Noise=(N*AE)−(N*AM*A*DE) (2)

where the algebraic operators refer to vector operations, using complex notation and arithmetic to compute amplitude and phase spectra.

For the avoidance of doubt, a frequency dependent transfer function X(f) is expressed as a vector, (Xᵣ+j Xᵢ) having real and imaginary components Xᵣ and Xᵢ respectively (and j the imaginary unit), in which the modulus, M, of the vector (the signal amplitude) and its phase angle, φ, have the following relationships.

$$\begin{matrix}M = \sqrt{{X}_{r}^{2} + {X}_{i}^{2}} & ( 3 ) \\ ϕ = arctan ( \frac{{X}_{i}}{{X}_{r}} ) & ( 4 )\end{matrix}$$

Consequently, the vector subtraction of function X from Y yields the following.

(Yᵣ+jYᵢ)−(Xᵣ+jXᵢ)=(Yᵣ−Xᵣ)+j(Yᵢ−jXᵢ) (5)

Similarly, the vector product of function X and Y (denoted X*Y above) yields the following.

(Yᵣ+jYᵢ)*(Xᵣ+jXᵢ)=(YᵣXᵣ−YᵢXᵢ)+j(YᵣXᵢ+YᵢXᵣ) (6)

The residual noise signal is calculated using these procedures, and can be displayed as an amplitude spectrum (the modulus of the residual noise vector), its phase being unimportant here at this final stage.

In order to minimise the residual noise signal, an electronic compensation stage is required to be associated with the amplifier, either as an integral filter designed around the amplifier itself, or simply as a serial stage, as shown in simplified form at 56 in FIG. 6. Accordingly, the mathematical transfer function of this filter, “SP” (signal processing), should now be interposed as part of the signal path in the electrical domain, as shown in FIG. 8, and so the calculation for residual noise now becomes the following.

Residual Noise=(N*AE)−(N*AM*A*SP*DE) (7)

The degree of noise-reduction can be expressed as “Residual Noise Fraction”, RNF, namely the ratio of the Residual Noise to the original ambient noise signal, N, thus.

RNF=(Residual Noise/N)=(AE)−(AM*A*SP*DE) (8)

This provides a convenient means of stating the effectiveness of the noise-reduction process when it is expressed in decibel units as the “Residual Noise Level”, RNL, as follows, indicating the amount of noise suppression.

RNL(dB)=20_{log10}{(AE)−(AM*A*SP*DE)} (9)

The signal processing parameters, for example the gain and cut-off frequency of a selected filter stage, are adjustable in real-time, controlled by a graphical display as part of the computer program. Usefully, this allows the user to inspect the residual noise level spectrum, and to iteratively adjust the filter parameters for optimum results (minimal residual noise) in the circumstances under review. When the user is satisfied with the qualities of the residual noise spectrum, the filter parameters are translated into the appropriate electronic component values for use in the signal processing filter or filters.

The invention thus, most usefully, allows one or more optimum or preferred solutions to be determined. Owing to the physical complexity of any real acoustical system of this sort, there is no one, perfect solution. It is unavoidable that time-delay discrepancies and spurious resonances, coupled with the finite frequency response of the loudspeaker, result in imperfect noise cancellation throughout the spectrum. By presenting the residual noise spectrum as a visual display during its iterative minimisation, the user can choose which parts of the spectrum to prioritise during the filter optimisation process, and optimise these regions at the expense of noise-cancellation elsewhere in the spectrum. Hence, the noise reduction can be “tuned” or “profiled” so as to match particular needs, for example as follows:
1. General purpose profile.
The residual signal is minimised with equal weighting throughout the spectrum, to provide a general purpose noise-reduction system.
2. Low-frequency weighted profile.
The residual signal is minimised so as to optimise noise reduction at low frequencies (say, below 200 Hz), for application where this is predominant, such as for underground rail travelers or factory work.
3 Spot frequency profile.
The residual signal is minimised at one (or more) specific frequency, where there is a known noise peak, for example in propeller aircraft where the blade rotation frequencies are known to be specifically 80 Hz or 120 Hz.
4. Band-optimised profile.
In cases where it is important to reduce noise within a particular range of frequencies, then the residual signal can be minimised accordingly. For example, in spoken communication applications, it is advantageous to minimise the residual noise signal in the speech band (270 Hz to 5600 Hz) in order to optimise the Articulation Index.

Examples of this process are provided in FIGS. 12 to 15, which derive from the three transfer function measurements of FIGS. 9, 10 and 11, described above. In these Figures, the dashed lines represent the predicted, mathematically modelled RNL spectrum, from which filter characteristics were obtained, and the solid lines represent subsequent measurements on the headphone system after physical implementation of the electronic signal processing. As can be seen, the measured data closely matches the modelled data.

FIG. 12 shows the residual noise level (RNL) that would be achieved from the above measurements without any signal processing, simply by using the “invert and add” method of FIG. 1. Cancellation is indeed achieved where both the phase and amplitude of the noise and cancellation signals are fortuitously similar (particularly at 450 Hz), aided by the flat response of the loudspeaker and the time-alignment of the multiple microphone array of FIG. 5, but the low frequency performance is poor. By minimising the residual noise, in accordance with an embodiment of this invention using a pair of first-order low-pass filters arranged as shown in FIG. 7, it is possible to produce several much improved cancellation profiles, as follows.

FIG. 13 shows the result of optimising the RNL for a general purpose profile, in which the residual noise level has been minimised throughout the spectrum with equal weighting. In comparison to the un-processed RNL spectrum of FIG. 12, the cancellation level has increased from a value of around −3 dB, at 100 Hz, to a value of −15 dB. The range of frequencies where more than −10 dB cancellation is achieved has increased from 250-1100 Hz to 70-1300 Hz. Also, in the range 150-1000 Hz, there is more than −20 dB cancellation.

FIG. 14 shows the result of optimising the RNL for a spot-frequency profile, here intended for an aviation application where the propeller frequency is 100 Hz, and the noise-reduction is required to be most effective at this frequency.

FIG. 15 shows the result of optimising the RNL for the speech band, between 270 Hz and 5600 Hz, to provide the an optimal articulation index and thereby improve the intelligibility of vocal communications.

The parameters of the two low-pass filters associated with these results are given in Table 1, below:

TABLE 1
Filter parameters for three noise-cancellation schemes
with differing noise-cancellation index profiles

| | | LPF 1 | | LPF 2 |
|---|---|---|---|---|
| NCI profile | LPF 1 | cut-off | LPF 2 | cut-off |
| type | gain | frequency | gain | frequency |
| NCI profile 1 | 1.0 | 884 Hz | 14.35 | 6.1 Hz |
| (general | | | | |
| purpose) | | | | |
| NCI profile 2 | 1.0 | 884 Hz | 14.35 | 6.1 Hz |
| (80 Hz) | | | | |
| NCI profile 3 | 1.0 | 482 Hz | 1.44 | 86.8 Hz |
| (speech | | | | |
| band) | | | | |

The above example was based on a relatively simple acoustical system for clarity of explanation, but it will be appreciated that the invention can be applied equally well to more complex acoustical systems, provided that a suitable signal-processing scheme can be identified, as described next.

### EXAMPLE 2

### In-Ear, “Ear-Bud” Type Noise-Canceling Earphone

The invention has been successfully applied to ESDs in the form of the popular “ear-bud” type earphones and, in particular, those which feature a thin rubber flange seal in order to provide a measure of acoustical isolation for the wearer, especially at higher frequencies. FIG. 16 shows the structure of such an ear-bud, and its location, in use, in the outer part of the ear canal. The rubber flanges can afford a relatively good acoustical seal, and behave as an acoustical high-cut filter. However, they do not attenuate the lower frequencies, up to about 500 Hz, owing to the compliance of the thin rubber. Consequently, the ambient-to-ear function (AE) exhibits a high-frequency roll-off, beginning at a frequency of several hundred Hz, which is not present in the previous, pad-on-ear example. Another consequence is that the phase of the AE function exhibits a negative offset at low frequencies.

Nevertheless, the AE, AM and DE transfer functions can be measured using an artificial ear canal system, similar to that of FIG. 16, and a signal processing scheme can be optimised and implemented for the ear-buds in question. In this specific instance, the artificial ear canal simulator system featured an ear canal entrance component, 11 mm diameter and 6 mm deep, so as to accommodate the standard sized 12 mm ear-bud sealing flange, in conjunction with a 7.5 mm diameter, 22 mm long canal-simulator element, with foam damping, terminated by a reference microphone (B&K type 4190).

The inventors hereof have discovered that the twin low-pass filter arrangements (FIG. 7) which were used for the pad-on-ear system are equally suitable for compensating the LF roll-off of the ear-bud microspeaker. In addition, they have discovered that the HF roll-off caused by the rubber flange seal can be compensated for by the addition of a single, first-order HF-cut filter to the said arrangement, as shown in FIG. 17, based around amplifier X4. For experimental convenience, this HF-cut filter was configured as an inverting high-pass filter such that its (inverted) high-pass output is added to the main signal pathway at the summing point at the inverting input of the final amplifier. Its high-pass output, being inverted, therefore becomes subtracted from the main signal, thereby providing a high-cut function. However, the HF-cut filter can be configured in several equivalent alternative ways, as will be appreciated.

Referring to FIG. 17, the signal from the microphone buffer amplifier is fed into node N1, from which it feeds amplifier X4; configured as a first-order high-pass filter, the output of which is summed (via R10) together with the original signal (via R6) by summing amplifier X3. As before, the output of X3 is fed from node N2 to the headphone driver amplifier via potentiometer A1, which allows the overall system gain to be trimmed for correct value. The high-frequency gain of stage X4 is set by the ratio (R9/R8), and the low frequency gain tends to zero owing to C3 in the input feed. The amplifier inverts the signal, which is added to the original, flat-response microphone signal. The cut-off frequency, F_{c}, of the filter is determined by the values of R9 and C3 according to the relationship: F_{C}=(½πRC).

Consequently, if X3 is set to unity-gain configuration, by setting R5, R6 and R7 to be all of equal value, then at high frequencies the gain of the entire circuit of FIG. 17, from N1 to N2, becomes very small (because the HF gain of X4 tends to R9/R8). As before, at low frequencies, it asymptotes to a value defined by: Gain_{LF}=1+{(R2/R1)×(R4/R3)} (where the “1” represents the contribution from N1 via R6).

By the addition of a suitable HF-cut stage to the previously described mathematical simulation, iterative optimisation of the signal-processing filters can be carried out to yield optimum results (minimal residual noise level), and then the filter parameters can be translated into the appropriate electronic component values for use in the signal processing filter or filters.

The physical results of such a process are shown graphically in FIG. 18, which shows (a) the response of the artificial ear canal system (as a reference; thin solid line); (b) the response after insertion of the ear-bud (dashed line); and (c) the response when the noise-cancellation system was activated (thick solid line). Here, these are not plotted as RNL values, but as actual sound pressure level measurements. It can be seen that, when the ear-bud is inserted, the ear-response (of the ear canal simulator) is attenuated for frequencies above 350 Hz by the rubber sealing flanges but, below this value, they have little or no effect. However, when the noise-cancellation is switched on, as indicated by the thick solid line, more than −15 dB cancellation can be achieved, down to 45 Hz. In these measurements, the cut-off frequency of the high-cut filter (FIG. 17) was 498 Hz.

It will be appreciated that the invention can be extended in its complexity well beyond the examples provided here; the main practical limit being the identification of a suitable complementary signal processing scheme to work with the acoustical characteristics of the ESD in question. For example, it was discovered that the Driver-to-Ear (DE) response of one particular headphone system required a small phase adjustment of 11° at 1 kHz for optimum cancellation at that frequency. This was implemented as a small, capacitive reactance in parallel with R6 in the manner of a phase-trimmer rather than a filter, and this was added mathematically to the residual noise calculation, enabling improved optimisation.

It will be further appreciated that the iterative optimisation routine can be automated and implemented as a computer algorithm, using well-known data-fitting methods such as, for example, minimising the sum of the residual noise values at a series of frequencies over a prescribed range. In a basic algorithm of this sort, the various filter parameters are iteratively adjusted in turn through a range of values, and the resultant, simulated, residual noise spectrum is analysed by summing together, at each iteration, the residual noise fraction at a series of frequency values. The optimum noise-cancellation occurs when this sum is at its minimum. The algorithm uses this criterion to find this optimum point and provide the associated filter parameters.

This invention lends itself well to the generation of different spectral noise-reduction profiles to meet differing criteria, as noted previously, such that the noise reduction can be “tuned” or “profiled” so as to match particular needs. This can be achieved by “weighting” the individual residual noise fractions in an appropriate way before they are summed together. For example, for the General Purpose profile (example 1), no weighting is required. However, for optimisation at low-frequencies, each individual residual noise fraction at frequency F could be multiplied by a weighting factor of 1/F, and so on. This approach is easy to modify for spot frequency and band-weighted optimisation, too.

Instead of, or in addition to, measurements on an artificial head, it is possible to make similar measurements on human individuals by the use of a probe microphone situated in the ear canal. Although this is less precise, because there is more experimental variation and noise, it is in principle a good method for the characterisation of ear-buds, where bone-conduction and skin-conduction processes occur that are difficult to simulate physically using a microphone adaptor.

1-21. (canceled)

22. A noise cancellation system suitable for use with an ear-bud having a thin rubber flange providing an acoustic seal in the ear of a user, the system comprising a filter, and the filter comprising:
first and second series-connected first-order low-pass filters connected to receive an input noise signal;
a first-order high frequency cut filter, connected to receive the input noise signal; and
a summing amplifier, for forming a sum of the input noise signal, an output of the first and second low-pass filters, and an output of the high frequency cut filter.

23. A noise cancellation system as claimed in claim 22, wherein the summing amplifier and the high frequency cut filter are such that a high pass output is effectively subtracted from the sum of the input noise signal and the output of the first and second low-pass filters.

24. An ear-bud speaker device, having a thin rubber flange providing an acoustic seal in the ear of a user, and comprising a noise cancellation system as claimed in claim 22.

25. An ear-bud speaker device, having a thin rubber flange providing an acoustic seal in the ear of a user, and comprising a noise cancellation system as claimed in claim 23.

26. An ear-bud earphone, having a thin rubber flange providing an acoustic seal in the ear of a user, and comprising a noise cancellation system comprising a filter, wherein the filter comprises:
first and second series-connected first-order low-pass filters connected to receive an input noise signal;
a first-order high frequency cut filter, connected to receive the input noise signal; and
a summing amplifier, for forming a sum of the input noise signal, an output of the first and second low-pass filters, and an output of the high frequency cut filter.

27. A personal music player system, comprising a personal music player and at least one ear-bud earphone as claimed in claim 26.

28. A personal music player system as claimed in claim 27, having a wired connection between the personal music player and the at least one ear-bud earphone.

29. A personal music player system as claimed in claim 27, having a wireless connection between the personal music player and the at least one ear-bud earphone.

30. A cellular phone system, comprising a cellular phone and at least one ear-bud earphone as claimed in claim 26.

31. A cellular phone system as claimed in claim 30, having a wired connection between the cellular phone and the at least one ear-bud earphone.

32. A cellular phone system as claimed in claim 30, having a wireless connection between the cellular phone and the at least one ear-bud earphone.
